(19) United States
(12) Patent Application Publication
(10) Pub. No.: US 2020/0263493 A1
(43) Pub. Date: Aug. 20, 2020

(54) DRIVING MECHANISM FOR ROLL BLIND CAPABLE OF SHADE ADJUSTMENT

(71) Applicants: Jong Hyun An, Gyeonggi-do (KR); Jongchan Ahn, Gyeonggi-do (KR)

(72) Inventors: Jong Hyun An, Gyeonggi-do (KR); Jongchan Ahn, Gyeonggi-do (KR)

(21) Appl. No.: 16/641,739

(22) PCT Filed: Aug. 23, 2018
(86) PCT No.: PCT/KR2018/009702

§ 371 Date: Feb. 25, 2020

(30) Foreign Application Priority Data
Sep. 4, 2017 (KR) 10-2017-0112363

(51) Int. Cl. E06B 9/68; E06B 9/50

(52) U.S. Cl. CPC E06B 9/68; E06B 9/80; E06B 9/50

(57) ABSTRACT

A driving mechanism for a roll blind capable of shade adjustment is proposed. The driving mechanism includes: a cover housing (212) having a stopper (212c) protrudingly foamed; a driving shaft (213a) relatively and rotatably coupled to the cover housing (212); a torsional coil spring (220) wound and tightened around an outer circumferential surface of the driving shaft (213a); and a clutch wheel (223) integrally rotating with the driving shaft (213a), wherein, in a case when the torsional coil spring (220) is caught by the stopper (212c) while the driving shaft (213a) is rotating, rotation of the torsional coil spring (220) is blocked therethrough, whereas the driving shaft (213a) is continuously rotatable regardless of whether the rotation of the torsional coil spring (220) is blocked, and wherein the driving mechanism further includes a tilting gear (222) and a tilting wheel (224) rotated in conjunction with the tilting gear (222).

### TECHNICAL FIELD

The present invention relates to a roll blind installed on a window frame. More particularly, the present invention relates to a driving mechanism for a roll blind enabling vertical control of a blind fabric for a shade adjustment without moving a weight upward and downward which flattens the blind fabric and is provided at the lower part thereof.

### BACKGROUND ART

Among roll blinds, a kind of roll blinds which is installed inside a window frame, that is, inside a box constituting the window frame, is widely used in the United States, Canada, and European countries.

FIG. 9 illustrates a so-called combination blind, among the roll blinds installed inside the window frame box, which allows front and rear fabrics 101 of the combination blind to cross with each other so as to make a shade adjustment possible.

In other words, in order to be accommodated in the space between double windows, a head frame 102 having a narrow front and back width W is applied thereto, the upper end of a front blind fabric 101a is fixed to the headframe 102, and a relative height difference between a rear blind fabric 101b and the front blind fabric 101a is generated as the upper end of the rear blind fabric 101b is wound or unwound on a tube 103, whereby there is provided a structure in which the shade adjustment is made.

In this case, at the lower end part where the front and rear blind fabrics 101a and 101b are connected to each other, a rod-shaped weight 104 is inserted thereinto to maintain the blind fabric 101 in a flattened state.

However, according to the conventional roll blind 100, there is a problem in that, in order to adjust the shade, the weight 104 at the lower end of the roll blind is raised or lowered whenever the rear blind fabric 101b is wound or unwound on a tube 103, whereby an open space is generated between the lower end of the window frame and the weight 104, and thus the inside a room is not completely blocked from the light.

In other words, the conventional roll blind 100 has a problem in that the open space is generated due to raising of the weight 104 in conjunction with adjusting the shade.

### DISCLOSURE

### Technical Problem

Accordingly, the objective of the present invention is to provide a driving mechanism for a roll blind that is capable of enabling a shade adjustment without raising or lowering a weight.

### Technical Solution

In order to achieve the objective of the present invention, there is provided a driving mechanism for a roll blind capable of shade adjustment, the driving mechanism including: a cover housing 212 having a stopper 212c protrudingly formed; a driving shaft 213a relatively and rotatably coupled to the cover housing 212; a torsional coil spring 220 wound and tightened around an outer circumferential surface of the driving shaft 213a; and a clutch wheel 223 integrally rotating with the driving shaft 213a, wherein, in a case when the torsional coil spring 220 is caught by the stopper 212c while the driving shaft 213a is rotating, rotation of the torsional coil spring 220 is blocked therethrough, whereas the driving shaft 213a is continuously rotatable regardless of whether the rotation of the torsional coil spring 220 is blocked, wherein the driving mechanism may further include a tilting gear 222 caught by the torsional coil spring 220 and rotated together therewith, and a tilting wheel 224 rotated in conjunction with the tilting gear 222 via an idle gear 218, and wherein, in a section in which the torsional coil spring 220 rotates together with the driving shaft 213a without being caught by the stopper 212c, the tilting wheel 224 is rotated due to the rotation of the torsional coil spring 220.

Here, the driving mechanism for the roll blind may further include: a guide ring 221 adjacent to the torsional coil spring 220 and inserted into the driving shaft 213a along an axis thereof, wherein the guide ring 221 may be caught by the torsional coil spring 220 through a first protrusion 221b protrudingly famed at one side of the guide ring 221 in an axial direction and rotated together therewith, and rotation of the guide ring 221 may be blocked when being caught by the stopper 212c through a second protrusion 221a protrudingly famed at the other side thereof in the axial direction, whereby the torsional coil spring 220 may be caught by the stopper 212c via the guide ring 221.

In addition, the driving shaft 213a passing through a plate surface of the cover housing 212 may be sequentially inserted into the guide ring 221, the torsional coil spring 220, the tilting gear 222, and the clutch wheel 223 along an axis thereof and coupled to one side surface of the cover housing 212, and a shaft cover 213 having the driving shaft 213a as a central axis thereof may be rotatably coupled to other side surface of the cover housing 212.

In addition, the driving mechanism for the roll blind may further include: a driving wheel 214 having a cavity therein, spaced apart around the driving shaft 213a, and rotatably coupled to the other side surface of the cover housing 212; and an operating line 211 for rotating the driving wheel 214 in engagement with teeth thereof formed along an outer circumference of the driving wheel 214, wherein the driving wheel 214 may be provided with a driving protrusion 214a protrudingly formed on an inner circumferential surface thereof, and the shaft cover 213 may be provided with a driven protrusion 213b protrudingly formed corresponding to the driving protrusion 214a, whereby the shaft cover 213 may be rotated due to pressurization in a circumferential direction by the driving protrusion 214a corresponding to the driven protrusion 213b when the driving wheel 214 rotates.

### Advantageous Effects

As described above, according to a roll blind of the present invention, since the amount of the blind fabric being unrolled at one side thereof is rolled up to the other side thereof by a tilting gear which is also rotating in conjunction with a clutch gear during the shade adjustment, the overall suspended length of the blind fabric does not change, and thus the weight remains in a same height without raising or lowering thereof.

Furthemore, components for adjusting the shade are arranged to be inserted into the driving shaft along the central axis thereof so as to be interlocked with each other, whereby transmission of the driving force may be performed more directly and smoothly. In addition, only tilting operation for adjusting the shade allows the idle gear and the tilting gear to be rotated in conjunction with each other, whereby the noise generated during the operation of the roll blind may be greatly reduced.

### DESCRIPTION OF DRAWINGS

FIG. 1 is a perspective view showing a roll blind to which a driving mechanism for the roll blind according to an exemplary embodiment of the present invention is applied.

FIG. 2 is an exploded view showing the roll blind of FIG. 1.

FIGS. 3 and 4 are detailed exploded views showing a main part of the roll blind of FIG. 2.

FIGS. 5 to 7 are side views for explaining a coupling state and an operation of the main part of the roll blind of FIG. 3.

FIG. 8 is a cross-sectional view showing the coupling state of the main part of the roll blind of FIG. 3.

FIG. 9 is a perspective view showing the roll blind according to the related art.

### BEST MODE

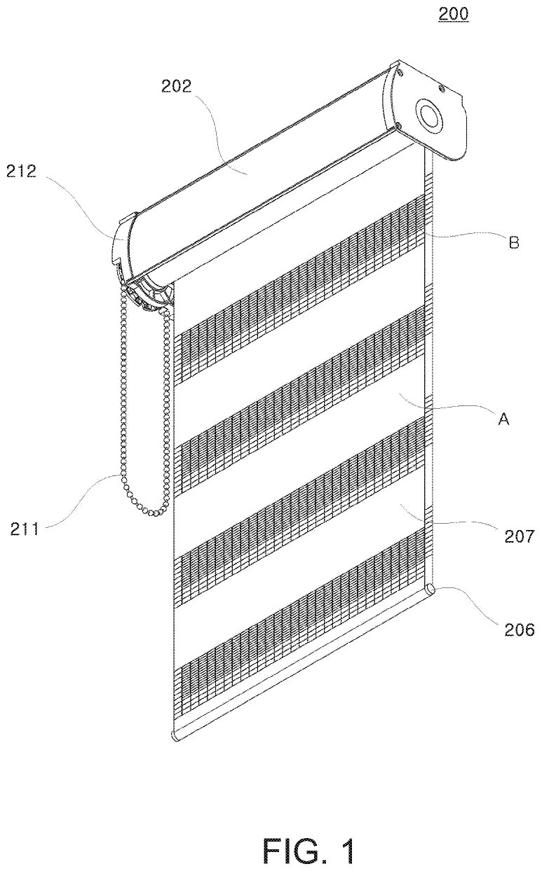

According to an exemplary embodiment of the present invention, a driving mechanism for a roll blind capable of shade adjustment is applied to a roll blind 200 shown in FIG. 1.

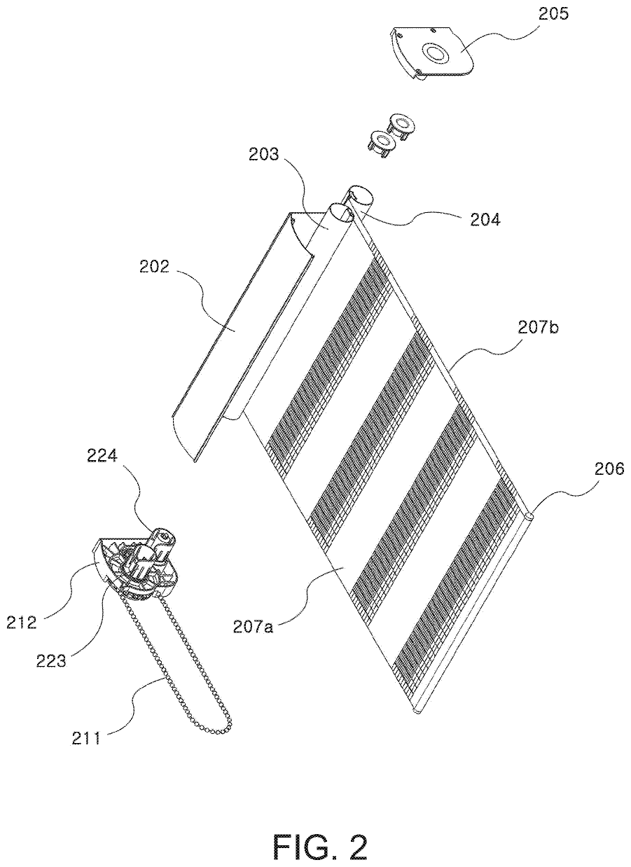

In the roll blind 200, an upper end of an operating line 211 is rotatably coupled to one side of a cover housing 212 at the upper end of the roll blind 200, and a user pulls the operating line 211 in one direction or the opposite direction, whereby a blind fabric 207 may be rolled up around a clutch tube 203 in a head frame 202 positioned at the upper end of the roll blind 200 or the blind fabric 207 which is wound around the clutch tube 203 may be pulled down, as shown in FIG. 2. A weight 206 is inserted into the lower end where a front and a rear blind fabric 207a and 207b meet with each other to keep the blind fabric 207 taut upright.

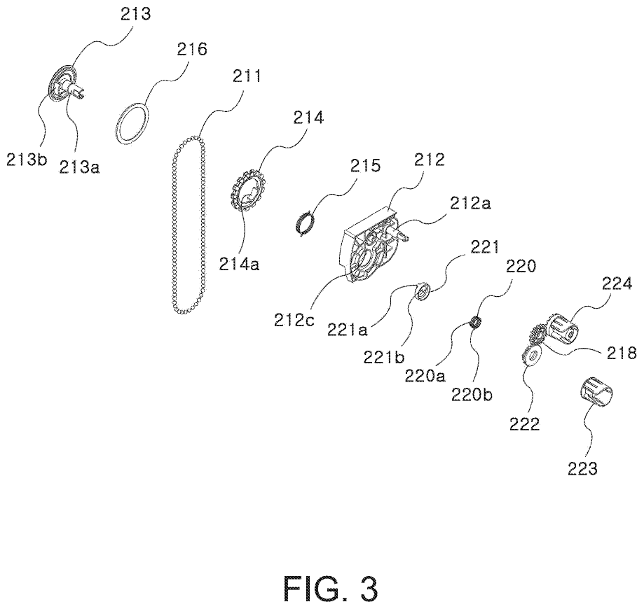

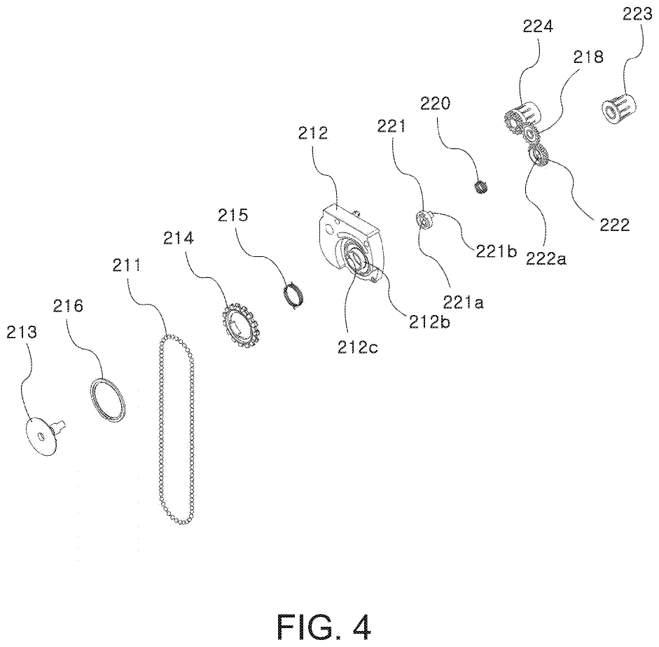

The driving mechanism for the roll blind capable of the shade adjustment according to the exemplary embodiment of the present invention includes one side of the cover housing 212 at the upper end of the roll blind 200 and the components installed therein, and more particularly, as shown in FIGS. 3 and 4, the driving mechanism includes: the cover housing 212; a shaft cover 213 having a driving shaft 213a rotatably coupled to the cover housing 212 passing therethrough; a guide ring 221, a torsional coil spring 220, a tilting gear 222, and a clutch wheel 223, which are sequentially inserted into the driving shaft 213a along the central axis thereof and coupled thereto; and an idle gear 218 and a tilting wheel 224 being rotated in engagement with the tilting gear 222 in sequence. In addition, the driving mechanism for the roll blind capable of shade adjustment further includes: a driving wheel 214 having a cavity in the center thereof; a second torsional coil spring 215; and a retainer 216, which are disposed on the outer surface of the cover housing 212.

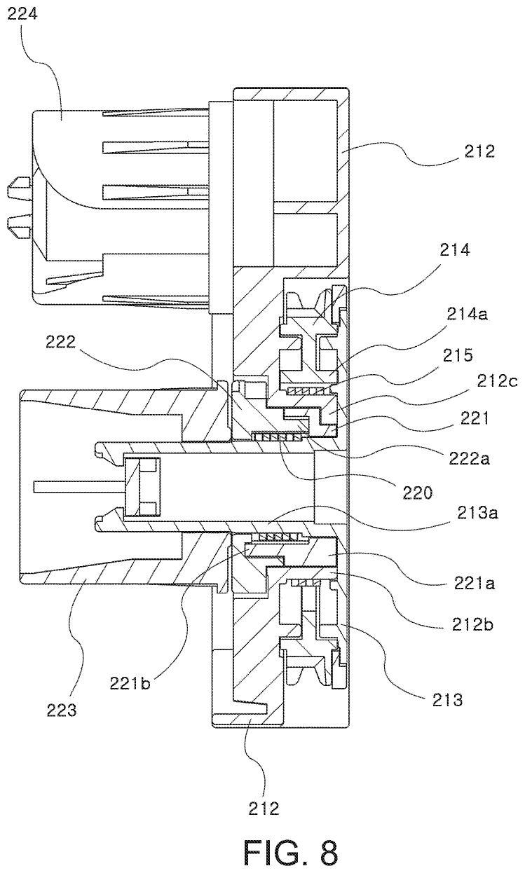

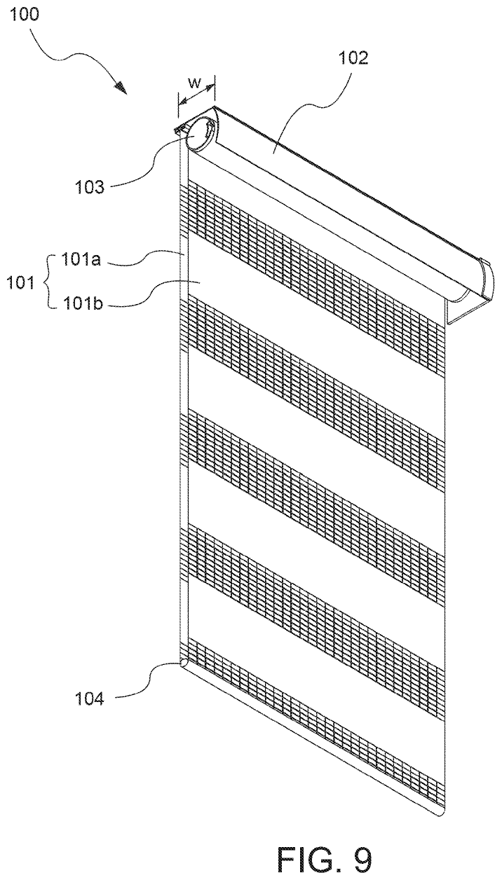

The cover housing 212 is provided with a cylindrical part 212b protruding toward the outer surface thereof, and a stopper 212c protruding from one side of the inner circumferential surface of the cylindrical part 212b. The second torsional coil spring 215 is wound and tightened around the outer circumferential surface of the cylindrical part 212b, and through this second torsional coil spring 215, the driving wheel 214 is fitted to the outer circumferential surface of the cylindrical part 212b and is rotatably coupled thereto (see FIG. 8). The driving wheel 214 is provided with teeth along the outer circumference and the operating line 211 is coupled to these teeth. The driving protrusion 214a is protrudingly formed on the inner circumferential surface of the driving wheel 214, and corresponding to this driving protrusion 214a, a driven protrusion 213b is protrudingly formed on the inner surface of the shaft cover 213, whereby, when the driving wheel 214 is rotated, the shaft cover 213 rotates as the driving protrusion 214a presses the driven protrusion 213b in the circumferential direction.

The retainer 216 is a component that makes the operating line 211 to be last inserted easily into the driving mechanism for the roll blind assembled in the above configurations.

The driving shaft 213a constituting the center of the axis of the shaft cover 213 passes through the cylindrical part 212b and protrudes toward the inner surface of the cover housing 212. The guide ring 221, which is first inserted into the driving shaft 213a along the axis thereof and is rotatably coupled thereto, is provided with a first protrusion 221b protrudingly famed on the inner side of the guide ring 221 along the axial direction thereof. In addition, the guide ring 221 is provided with a second protrusion 221a protrudingly formed on the opposite outer side thereof. Accordingly, when the second protrusion 221a is caught by the stopper 212c on the cover housing 212 side while the guide ring 221 is rotating, the rotation is blocked.

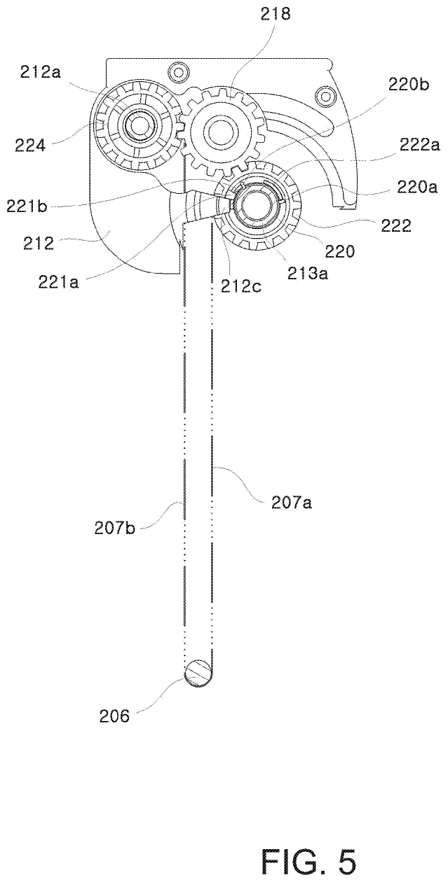

The torsional coil spring 220 adjacent to the guide ring 221 and inserted into the driving shaft 213a along the central axis thereof is wound around the outer circumferential surface of the driving shaft 213a and is maintained in a tightened state, thereby integrally rotating together with the driving shaft 213a by the tightening force. At this time, as the first protrusion 221b is pushed in the circumferential direction thereof by any one of the two locking protrusions 220a and 220b, which are protruding toward the outside of the torsional coil spring 220, the guide ring 221 is integrally rotated. When the second protrusion 221a of the guide ring 221 is caught by the stopper 212c in this process, the rotation of the guide ring 221 and the torsional coil spring 220 is blocked at the same time, that is, stopped (see FIG. 5). However, even in this case, the driving shaft 213a may continue to rotate in the same direction (i.e., in the counterclockwise direction shown in FIG. 5). In this state, the driving shaft 213a is in an idle state in the inner side of the torsional coil spring 220 which is in a fixed state.

Referring to FIGS. 3, 4, and 8, through the inner end part of the driving shaft 213a, the clutch wheel 223 is coupled thereto to integrally rotate, and the clutch wheel 223 is inserted into the clutch tube 203 as shown in FIG. 2 to integrally rotate. Therefore, in the case when the driving shaft 213a continues to rotate counterclockwise in the above state, that is, in the state shown in FIG. 5, the one side blind fabric 207a is unwound and lowered downward.

When the driving shaft 213a is rotated in the clockwise direction in the state shown in FIG. 5, the torsional coil spring 220 is able to rotate clockwise together with the driving shaft 213a after the one side locking protrusion 220b becomes free from the first protrusion 221b.

Meanwhile, in FIGS. 3 and 4, the tilting gear 222 is inserted into the driving shaft 213a along the central axis thereof and is rotatably coupled to the inner side of the torsional coil spring 220. At this time, on the outer side surface of the tilting gear 222, that is, on the side surface toward the torsional coil spring 220, a pressing protrusion 222a is protrudingly foLmed. When the torsional coil spring 220 rotates, the pressing protrusion 222a is pressed in the circumferential direction by any one of the two locking protrusions 220a and 220b, whereby the tilting gear 222 is rotated.

In other words, when the driving shaft 213a rotates in the clockwise direction in the state shown in FIG. 5, the one side locking protrusion 220b of the torsional coil spring 220, which rotates together with the driving shaft 213a, rotates in a clockwise direction to pressurize the pressing protrusion 222a, thereby making the tilting gear 222 rotate clockwise.

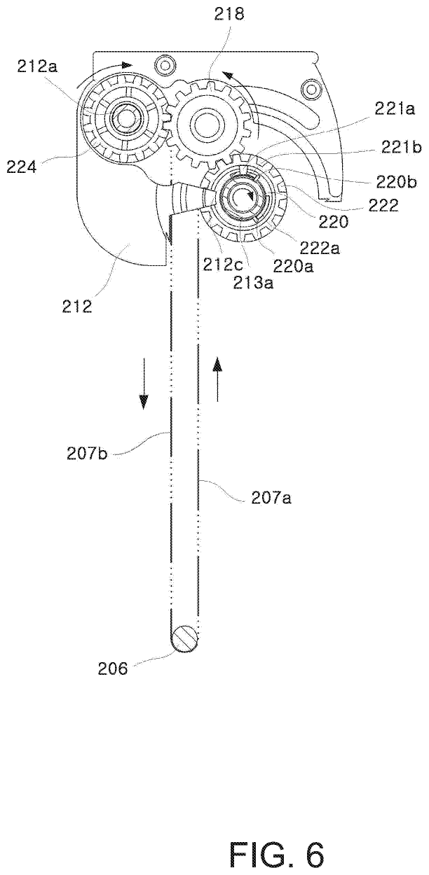

In addition, due to the clockwise rotation of the tilting gear 222, the idle gear 218 and the tilting wheel 224, which are meshed with the tilting gear 222, rotate in conjunction with each other. Thus, in this process, a tilting operation occurs. Since the driving shaft 213a rotates in the clockwise direction, the clutch wheel 223 also rotates clockwise so that the one side blind fabric 207a is wound and raised as shown in FIG. 6. In addition, since the tilting wheel 224 via the idle gear 218 also rotates in the clockwise direction due to the tilting gear 222 rotating in the clockwise direction as described above, the other side blind fabric 207b, which has been wound to some extent, is unwound and lowered downward.

Accordingly, during this tilting operation, since only the both side blind fabrics 207a and 207b are raised and lowered by the same amount without raising or lowering the entire blind fabric 207. As a result, adjusting the shade of the roll blind is made possible therethrough.

In FIG. 6, the reason why the pressing protrusion 222a is rotated to the other side locking protrusion 220a is because self-load (in a clockwise direction), being acted to the tilting wheel 224 side, of the other side blind fabric 207b is transmitted to the tilting gear 222 through the idle gear 218 when the user releases the operating line 211.

Meanwhile, the rotational force due to the self-load of the blind fabrics 207a and 207b, regardless of one side or the other side thereof, is transmitted to the driving shaft 213a, is transmitted to the second torsional coil spring 215 via the driven protrusion 213b, and is supported by the tightening force of the second torsional coil spring.

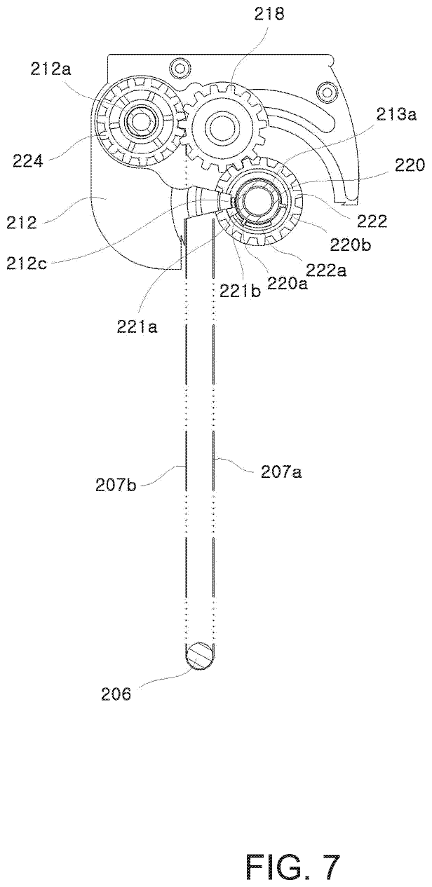

The angle enabling the shade adjustment is explained as follows: referring to the state shown in FIG. 5, the torsional coil spring 220 rotates one turn in a clockwise direction. Subsequently, the one side locking protrusion 220b pushes the lower end part of the first protrusion 221b of the guide ring 221. After that, the torsional coil spring 220 rotates again together with the guide ring 221 to rotate one more turn. Finally, the shade adjustment is able to rotate only about an angle approximately two turns until getting to the state shown in FIG. 7 in which the second protrusion 221a of the guide ring 221 is caught by the stopper 212c. (In detail, a rotational angle capable of the shade adjustment=720 degrees−{an angle of the second protrusion 221a+an angle of the first protrusion 221b+an angle of the pressing protrusion 222a}, wherein the theoretical angle is about 620 degrees, and the actual angle is about 540 degrees).

In other words, by additionally installing the guide ring 221 at a position between the torsional coil spring 220 and the stopper 212c, the range of angles capable of the shade adjustment may be greatly expanded.

Meanwhile, since the roll blind 200 and the driving mechanism for the roll blind applied thereto are only one exemplary embodiment for better understanding of the present invention, it should be understood that the scope of the present invention and the technical scope is not limited to those described above.

The scope of the present invention to the technical scope is defined by the claims and equivalents described below.

1. A driving mechanism for a roll blind capable of shade adjustment, the driving mechanism comprising:
a cover housing (212) having a stopper (212c) protrudingly formed;
a driving shaft (213a) relatively and rotatably coupled to the cover housing (212);
a torsional coil spring (220) wound and tightened around an outer circumferential surface of the driving shaft (213a); and
a clutch wheel (223) integrally rotating with the driving shaft (213a),
wherein, in a case when the torsional coil spring (220) is caught by the stopper (212c) while the driving shaft (213a) is rotating, rotation of the torsional coil spring (220) is blocked thereby, whereas the driving shaft (213a) is continuously rotatable regardless of whether the rotation of the torsional coil spring (220) is blocked,
wherein the driving mechanism further comprises a tilting gear (222) caught by the torsional coil spring (220) and rotated together therewith, and a tilting wheel (224) rotated in conjunction with the tilting gear (222) via an idle gear (218), and
wherein, in a section in which the torsional coil spring (220) rotates together with the driving shaft (213a) without being caught by the stopper (212c), the tilting wheel (224) is rotated due to the rotation of the torsional coil spring (220).

2. The driving mechanism of claim 1, further comprising:
a guide ring (221) adjacent to the torsional coil spring (220) and inserted into the driving shaft (213a) along an axis thereof, wherein the guide ring (221) is caught by the torsional coil spring (220) through a first protrusion (221b) protrudingly formed at one side of the guide ring (221) in an axial direction and rotated together therewith, and rotation of the guide ring (221) is blocked when being caught by the stopper (212c) through a second protrusion (221a) protrudingly formed at the other side thereof in the axial direction, whereby the torsional coil spring (220) is caught by the stopper (212c) via the guide ring (221).

3. The driving mechanism of claim 2, wherein the driving shaft (213a) passing through a plate surface of the cover housing (212) is sequentially inserted into the guide ring (221), the torsional coil spring (220), the tilting gear (222), and the clutch wheel (223) along an axis thereof and coupled to one side surface of the cover housing (212), and a shaft cover (213) having the driving shaft (213a) as a central axis thereof is rotatably coupled to other side surface of the cover housing (212).

4. The driving mechanism of claim 3, further comprising:
a driving wheel (214) having a cavity therein, spaced apart around the driving shaft (213a), and rotatably coupled to the other side surface of the cover housing (212); and
an operating line (211) for rotating the driving wheel (214) in engagement with teeth thereof formed along an outer circumference of the driving wheel (214),
wherein the driving wheel (214) is provided with a driving protrusion (214a) protrudingly famed on an inner circumferential surface thereof, and the shaft cover (213) is provided with a driven protrusion (213b) protrudingly formed corresponding to the driving protrusion (214a), whereby the shaft cover (213) is rotated due to pressurization in a circumferential direction by the driving protrusion (214a) corresponding to the driven protrusion (213b) when the driving wheel (214) rotates.
